(19) United States
(12) Patent Application Publication
(10) Pub. No.: US 2024/0101218 A1
(43) Pub. Date: Mar. 28, 2024

(54) YAMAHA TENERE 700 REAR BRAKE PEDAL

(71) Applicant: Cory L. HANSON, Calgary (CA)

(72) Inventor: Cory L. HANSON, Calgary (CA)

(21) Appl. No.: 18/469,746

(22) Filed: Sep. 19, 2023

(30) Foreign Application Priority Data
Sep. 22, 2022 (CA) 3175338

(51) Int. Cl. B62L 3/04

(52) U.S. Cl. CPC B62L 3/04

(57) ABSTRACT

The leverage ratio of the rear brake pedal of the Yamaha Tenere 700 (XTZ690) motorcycle is changed to allow the rear brake to be activated properly with substantially less pedal travel. This leads to firmer pedal feel, faster braking and less ankle deflection to properly apply the brake. The pivot point of the brake pedal is fixed on the bike's frame so it cannot be moved so the short side of a new pedal has been lengthened rearward creating more upward motion to the master cylinder with less movement of the long side of the lever. The master cylinder's pushrod is then out of alignment with the master cylinder due to the lengthened brake pedal. A newly designed offset clevis is added to realign the pushrod with the master cylinder.

### CROSS-REFERENCE TO RELATED APPLICATIONS

This application claims the benefit of priority of Canadian Patent Application No. 3,175,338 filed Sep. 22, 2022, which is incorporated herein by reference.

### BACKGROUND OF THE INVENTION

### (1) Field of the Invention

The invention pertains generally to the Yamaha Tenere 700 (XTZ690) motorcycle. More specifically, the invention relates to changing the leverage ratio of the rear brake pedal of the Yamaha Tenere 700 (XTZ690) motorcycle to reduce required pedal travel distance and improve braking speed.

### (2) Description of the Related Art

The Yamaha Tenere 700 (XTZ690) motorcycle has a very weak rear brake system. This is due to a very long lever ahead of the pedal's pivot point and an inadequate length lever after the pivot point. The brake pedal must travel a large distance to create enough movement at the master cylinder to activate the brake properly. This long travel means the rider needs to use a lot of ankle deflection to activate the rear brake. The excessive movement creates weak and dangerous braking. This exaggerated movement can be difficult to achieve especially when wearing motorcycle boots.

Companies are offering braided stainless steel brake lines in hopes of reducing line swelling (associated with the OEM rubber lines) enough that less pedal travel is required. Other people/companies are installing different brake master cylinders that are a larger bore in order to move more fluid with the less lever stroke.

There are some limitations and drawbacks of the currently available approaches because the current solutions are merely working around the root cause of the problem, which is an incorrect leverage ratio in the rear brake pedal.

### BRIEF SUMMARY OF THE INVENTION

According to an exemplary embodiment of the invention there is disclosed a method of correcting the problem Yamaha Tenere 700 (XTZ690) motorcycle rear brake pedal by changing the leverage ratio of the pedal.

According to another exemplary embodiment of the invention there is disclosed one or more parts for changing the master cylinder pushrod activation location of the rear brake pedal of the Yamaha Tenere 700 (XTZ690) motorcycle.

According to another exemplary embodiment of the invention there is disclosed an improved rear brake pedal assembly for the Yamaha Tenere 700 (XTZ690) motorcycle.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a side view of a novel brake pedal for changing the master cylinder pushrod activation location from the original OEM location to an updated location according to an exemplary embodiment.

FIG. 2 shows a plan view of an offset clevis to realign the pushrod with the master cylinder according to an exemplary embodiment.

FIG. 3 shows a side view of the offset clevis of FIG. 2.

FIG. 4 shows a perspective view of the offset clevis of FIG. 2.

FIG. 5 illustrates a first side angle view of the rear brake pedal area of a Yamaha Tenere 700 (XTZ690) motorcycle having the brake pedal of FIG. 1 and offset clevis of FIG. 2 installed according to an exemplary embodiment.

FIG. 6 illustrates a second side angle view of the rear brake pedal area of a Yamaha Tenere 700 (XTZ690) motorcycle having the brake pedal of FIG. 1 and offset clevis of FIG. 2 installed according to an exemplary embodiment.

FIG. 7 illustrates a third side angle view of the rear brake pedal area of a Yamaha Tenere 700 (XTZ690) motorcycle having the brake pedal of FIG. 1 and offset clevis of FIG. 2 installed according to an exemplary embodiment.

### DETAILED DESCRIPTION

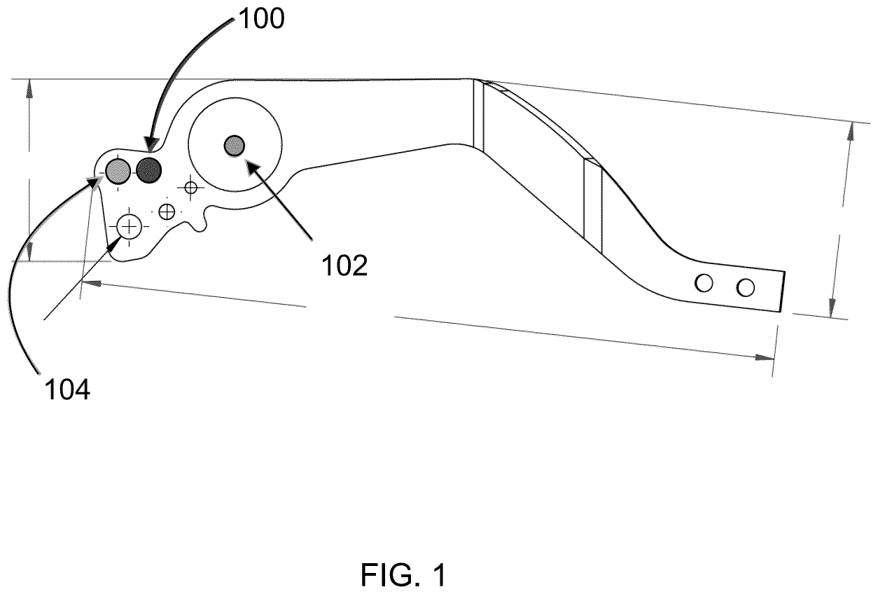

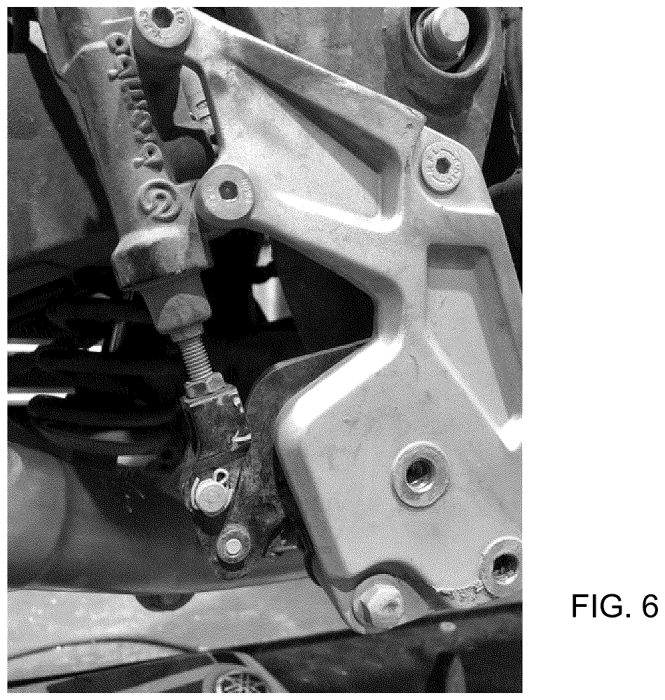

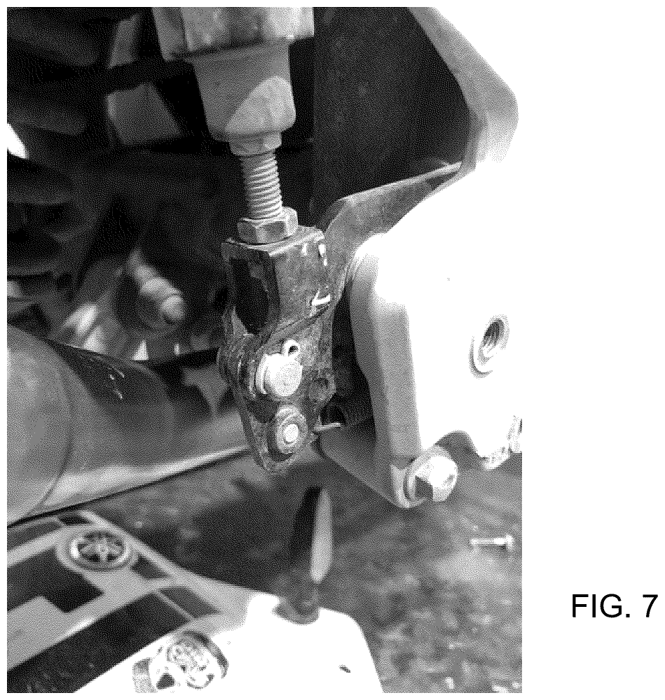

As shown in FIGS. 1-7, in exemplary embodiments disclosed herein, the leverage ratio of the rear brake pedal of the Yamaha Tenere 700 (XTZ690) motorcycle is changed to allow the rear brake to be activated properly with substantially less pedal travel. This leads to firmer pedal feel, faster braking and less ankle deflection to properly apply the brake.

In FIG. 1, the following elements are illustrated:

| Reference numeral | Description |
|---|---|
| 100 | OEM Master cylinder pushrod activation location |
| 102 | Pivot/Fulcrum location |
| 104 | Updated Master cylinder pushrod activation location |

The pivot point of the brake pedal is fixed on the bike's frame so it cannot be moved so the short side of a new pedal has been lengthened rearward creating more upward motion to the master cylinder with less movement of the long side of the lever. This is shown in particular in FIG. 1.

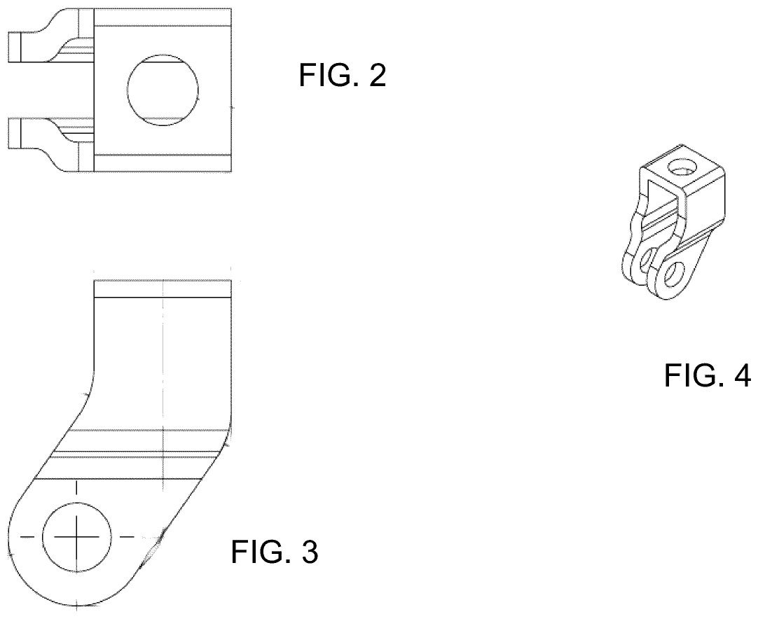

The master cylinder's pushrod is then out of alignment with the master cylinder due to the lengthened brake pedal. A newly designed offset clevis, illustrated in particular in FIGS. 2-4, is added to realign the pushrod with the master cylinder.

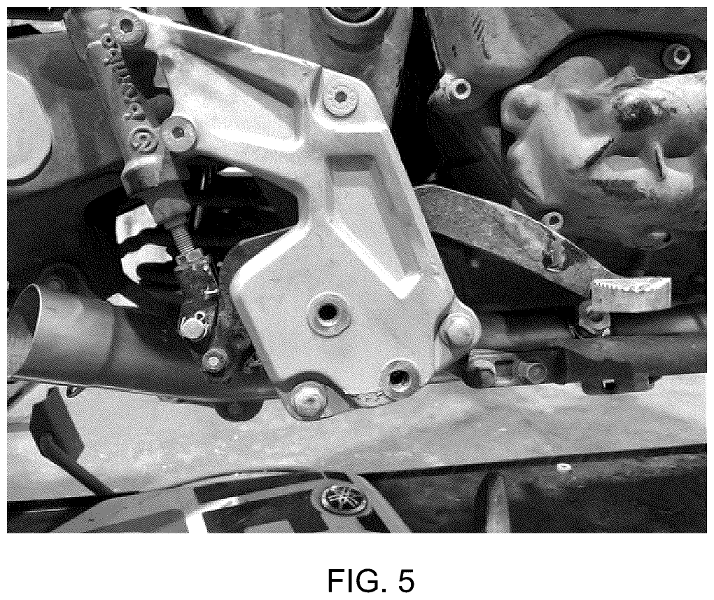

A method of correcting the problem Yamaha Tenere 700 (XTZ690) motorcycle rear brake pedal according to an exemplary embodiment includes changing the leverage ratio of the pedal by installing the above described parts as shown in the attached figures, in particular installing the parts as shown in FIGS. 5-7.

Although the invention has been described in connection with preferred embodiments, it should be understood that various modifications, additions and alterations may be made to the invention by one skilled in the art without departing from the spirit and scope of the invention. For instance, the installation steps and method are not restricted to the exact order shown, and, in other configurations, shown steps may be omitted or other intermediate steps added. All combinations and permutations of the above described features and embodiments may be utilized in conjunction with the invention.

What is claimed is:

1. An apparatus as shown or described herein.

2. A system as shown or described herein.

3. A method as shown or described herein.
